(19) United States
(12) Patent Application Publication
(10) Pub. No.: US 2014/0289128 A1
(43) Pub. Date: Sep. 25, 2014

(54) ONLINE POINT REDEMPTION AND DISTRIBUTION SYSTEM AND METHOD

(71) Applicant: ZHENG-XIAN QIU, Taoyuan County (TW)

(72) Inventor: ZHENG-XIAN QIU, Taoyuan County (TW)

(21) Appl. No.: 14/298,921

(22) Filed: Jun. 8, 2014

Related U.S. Application Data
(63) Continuation-in-part of application No. 13/437,925, filed on Apr. 2, 2012.

(30) Foreign Application Priority Data
Feb. 13, 2012 (TW) 101104480

(51) Int. Cl. G06Q 30/02

(52) U.S. Cl. CPC G06Q 30/0226
USPC 705/64

(57) ABSTRACT

An online point redemption and distribution system and method. The online point redemption and distribution system is used in combination with a cloud computing operating system to allow consumers and stores to do transaction online, every transaction between the consumers and the stores will be recorded as points, and then the points can be redeemed into virtual money and deposited in consumer's account. Therefore, it will enhance consumers' loyalty. The online point redemption and distribution system comprises a website operation platform and an application programming interface module.

This application is a continuation in part of U.S. patent application Ser. No. 13/437,925, which claims the benefit of the earlier filing date of Apr. 2, 2012.

### BACKGROUND OF THE INVENTION

1. Field of the Invention

The present invention relates to network communication field, and more particularly to an online point redemption and distribution system and method.

2. Description of the Prior Art

Today, blog has become one of the most popular methods of interactive communications among modern people. Therefore, most of the physical retail outlets have their own blogs or websites to advertise products and attract consumer's attention.

Virtual stores mostly pay to become members of an online shopping website which provides functionality on buying and selling goods, so that virtual store owners don't have to set up their own website. Virtual stores can also promote sales by paying to increase exposure rate.

However, the abovementioned advertising strategies are also used by competitors to distract consumers. Therefore, it will enhance consumers' loyalty if they can get reward after each online purchase.

The present invention has arisen to mitigate and/or obviate the afore-described disadvantages.

### SUMMARY OF THE INVENTION

The primary object of the present invention is to provide an online point redemption and distribution system and method. The online point redemption and distribution system is connected to a cloud computing operating system to allow consumers and stores to do transaction online, every transaction between the consumers and the stores will be recorded as points, and then the points can be redeemed into virtual money and deposited in consumer's account. Therefore, it will enhance consumers' loyalty.

To achieve the above object, an online point redemption and distribution system used in combination with a cloud computing operating system to calculate and save points produced by online transaction, comprises a website operation platform and an application programming interface module.

The website operation platform is connected to the cloud computing operating system to allow consumers and stores to do transaction online, a transaction history record is formed and stored in the cloud computing operating system after transaction. The application programming interface module is stored in cloud computing operating system to allow the stores or consumers to access the cloud computing operating system via the website operation platform. The application programming interface module includes a point distribution interface is provided with a distribution data, the distribution data includes parameters and weighting factors, and the parameters include store's designation, consumer level, recommendation, consumption points, quantity of order, and groups. The stores can create different distribution data for different consumers. Based on the distribution data and the transaction history record, the cloud computing operating system calculates and distributes the points produced by each actual or online transaction to individuals designated by the distribution mode, namely, the existing or potential consumers, so as to encourage the existing or potential consumers to redeem the points or purchase the commodities from the stores. A point redemption interface is provided with a redemption data, so that points earned by the consumers from different stores are added up and converted into virtual money. A point read interface is used to read balance of points and virtual money in a consumer account. A website background management system is used for managing the cloud computing operating system and the cloud computing operating system and the website operation platform.

An online point distribution method for used in combination with the online point redemption and distribution system of the present invention comprises the following steps:

making stores access the website operation platform by inputting a user account;

forming an encrypted distribution data in the point distribution interface and sending the encrypted distribution data to the memory module;

sending a point distribution request to the computing module of the cloud computing operating system from the memory module when a transaction history record is outputed to the memory module from the website operation platform;

using the computing module to decode the encrypted distribution data stored in the memory module;

using the computing module to store the points in the user account and other designated user accounts based on a decoded distribution data; and

displaying a point distribution result on the website operation platform.

An online point redemption method for used in combination with the online point redemption and distribution system of the present invention comprises the following steps:

making stores access the website operation platform by inputting a user account;

accessing the point redemption interface;

obtaining an application programming interface key corresponding to the user account, then inputting the application programming interface key into the point distribution interface;

setting a distribution data which includes the user account, the consumer identification code, the percentage of points of the stores and the consumers and corresponding distribution mode by using the point distribution interface, the distribution data includes parameters and weighting factors, and the parameters include store's designation, consumer level, recommendation, consumption points, quantity of order, and groups;

encrypting and packaging the distribution data, and sending the encrypted distribution data to the memory module of the cloud computing operating system.

### BRIEF DESCRIPTION OF THE DRAWINGS

FIG. 1 is a diagram showing an online point redemption and distribution system in accordance with a preferred embodiment of the present invention;

FIG. 1-1 shows the distribution data in accordance with the present invention;

FIG. 1-2 shows a distribution mode in accordance with the present invention;

FIG. 2 is a diagram showing an application programming interface module in accordance with the present invention;

FIG. 3 is a flow chart showing an online point distribution method in accordance with the present invention; and

FIG. 4 is a flow chart showing an online point redemption method in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

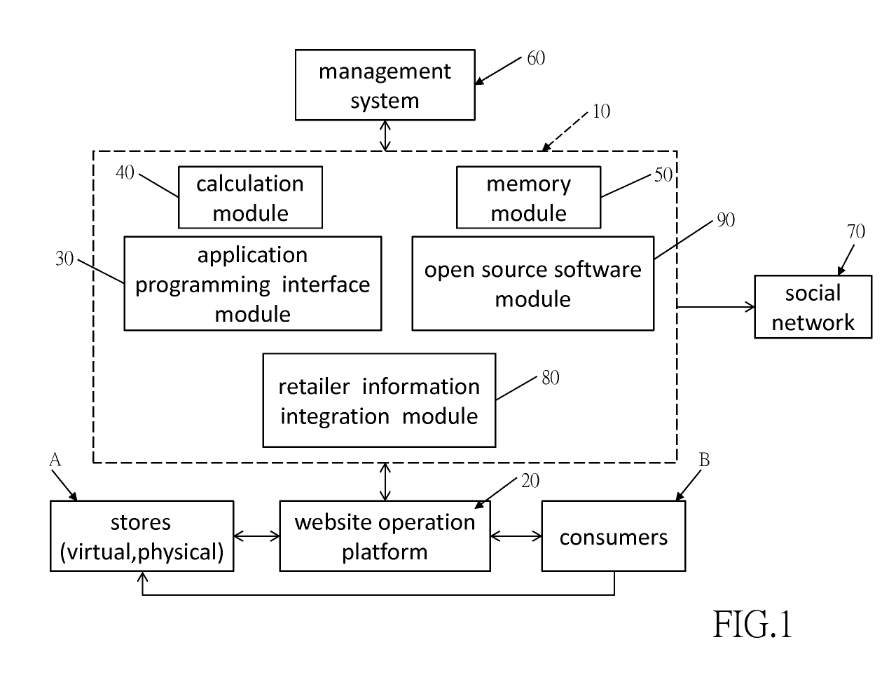

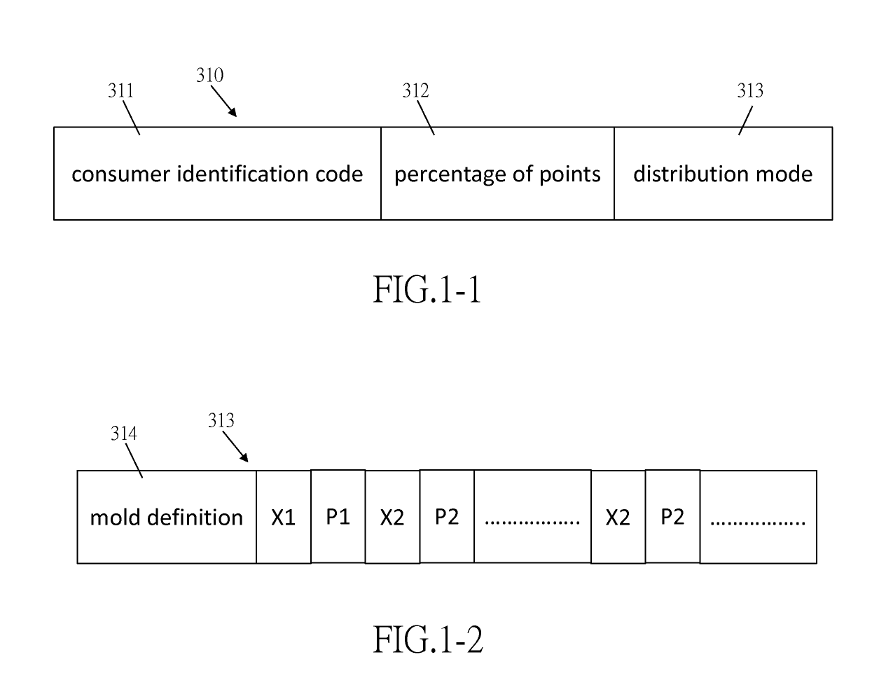

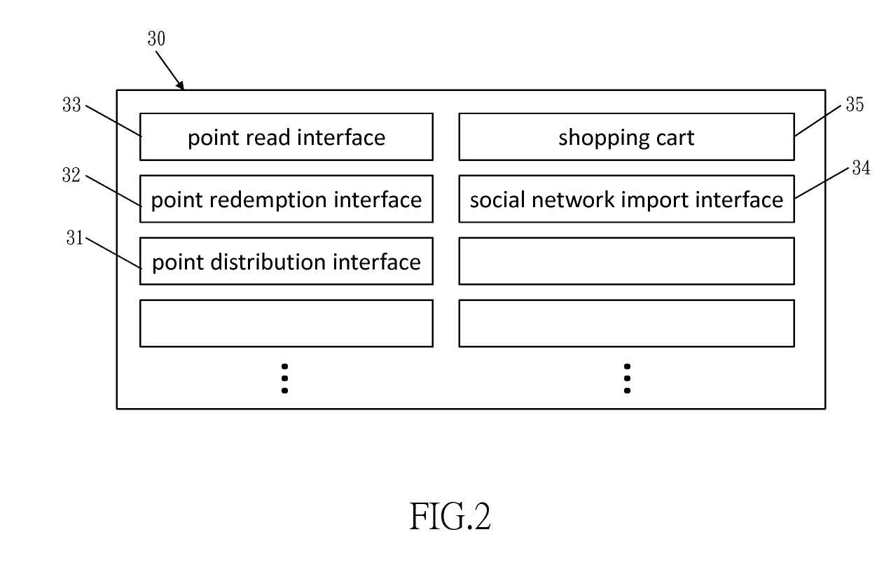

Referring to FIGS. 1 and 2, an online point redemption and distribution system in accordance with a preferred embodiment of the present invention is used in combination with a cloud computing operating system 10 to calculate and save the points produced by online transaction. The online point redemption and distribution system comprises a website operation platform 20 connected to a website background management system 60 via the cloud computing operating system 10, an application programming interface module 30 stored in the cloud computing operating system 10, a calculation module 40, a memory module 50, and a retailer information integration module 80.

An user interface of the website operation platform 20 connected to cloud computing operating system 10 allows consumers B and stores A to get into cloud computing operating system 10 to look through commodity information, buying and selling commodities, or changing data. Every transaction between the consumers B and the stores A will be recorded in transaction history in the memory module 50 of cloud computing operating system 10.

The website background management system 60 is connected to cloud computing operating system 10 to manage cloud computing operating system 10 and website operation platform 20.

The retailer information integration module 80 is provided for integrating physical stores and virtual stores and providing the respective stores A with their own exclusive cyber space to display commodity information, so that the consumers B can look through the information and do transaction through website operation platform 20. When the blogs of the virtual stores are integrated with the online point redemption and distribution system of the present invention, the virtual stores can obtain application programming interface module 30 via cloud computing operating system 10 and use application programming interface module 30 to perfect the blog, thus facilitating online transaction. Furthermore, when an independent website of the stores A is integrated with the online point redemption and distribution system of the present invention, the stores A can use an open source software module 90 stored in cloud computing operating system 10 to quick expand the function of the website.

In this embodiment, application programming interface module 30 is essentially provided for allowing the stores A to have access to cloud computing operating system 10 via website operation platform 20 to select the application programming interface module 30, and put the application programming interface module 30 into the exclusive cyber space of the retailer information integration module 80. Application programming interface module 30 comprises a point distribution interface 31 (hereafter called as API 31), a point redemption interface 32 (hereafter called as API 32), and a point read interface 33 (hereafter called as API 33).

The API 31 allows the stores A to preset a distribution data 310, based on the distribution data and the transaction history record, cloud computing operating system 10 calculates and distributes the points produced by transactions.

The distribution data 310, as shown in FIG. 1-1, includes consumer identification code 311 of the consumers who come to the stores A, a percentage 312 of points produced by each transaction that the consumers B made, and a distribution mode 313.

The distribution mode 313, as shown in FIG. 1-2, includes parameters P and weighting factors X. The parameters P include store's designation P1, consumer level P2, recommendation P3, consumption points P4, quantity of order P4, groups P5, other connections P6. The weighting factors X include different weighting factors X1-X6 used in combination with the different parameters P to form different distribution modes 313. Different distribution modes 313 have different mold definitions 314, such as VIP, high level, middle level and low level, so that the stores can choose a distribution mode 313 as they desired, and can micro-adjust the parameters P and the weighting factors X of the selected distribution mode 313.

The definitions of the parameters P includes:

The store's designation P1: the stores B decide whether or not and how to distribute.

The consumer level P2: define the level and percentage of the distribution, for example, consumers can be divided into 6 levels, each level corresponds to a specific percentage of distribution, and the stores can select one of the levels.

The recommendation P3: define where the consumers came from, for example, from the internet or recommended by other consumers, so that the consumers from the Internet become a source of upper level points, and those recommended by other consumers form the points to be distributed at the lower level.

The consumption points P4: calculate the total value of money of the past transactions (consumptions) and convert it into points.

The quantity of order P4: the quantity of virtual or actual orders made in the stores.

The groups P5: classify the consumers into groups of male, female or other groups with special needs.

Others connections P6: define the parameters related to the groups or other connections.

The weighting factors X can be adjusted (reduced or increased) based on the parameters P, and the stores can create different distribution data 310 for different consumers based on groups, or forms of sales promotion or different times, so that the points for each transaction (consumption) of the consumers can be counted and effectively distributed.

The API 32 allows the consumers B to preset a redemption data, so that the points earned by the consumers from different stores can be added up and converted into virtual money. The API 33 allows the consumers B to read the balance of points and virtual money of the consumers' account.

Application programming interface module 30 further comprises a social network import interface 34 (hereafter called as API 34) and a shopping cart 35 (hereafter called as API 35). The API 34 allows the stores A to import a social network 70 into their exclusive cyber space in the online point redemption and distribution system of the present invention, so that the subscribers to the social network 70 can be linked to the online point redemption and distribution system. The API 35 allows the stores A whose blogs are integrated with the retailer information integration module 80 to insert the API 35 into their blogs, making online transaction easier.

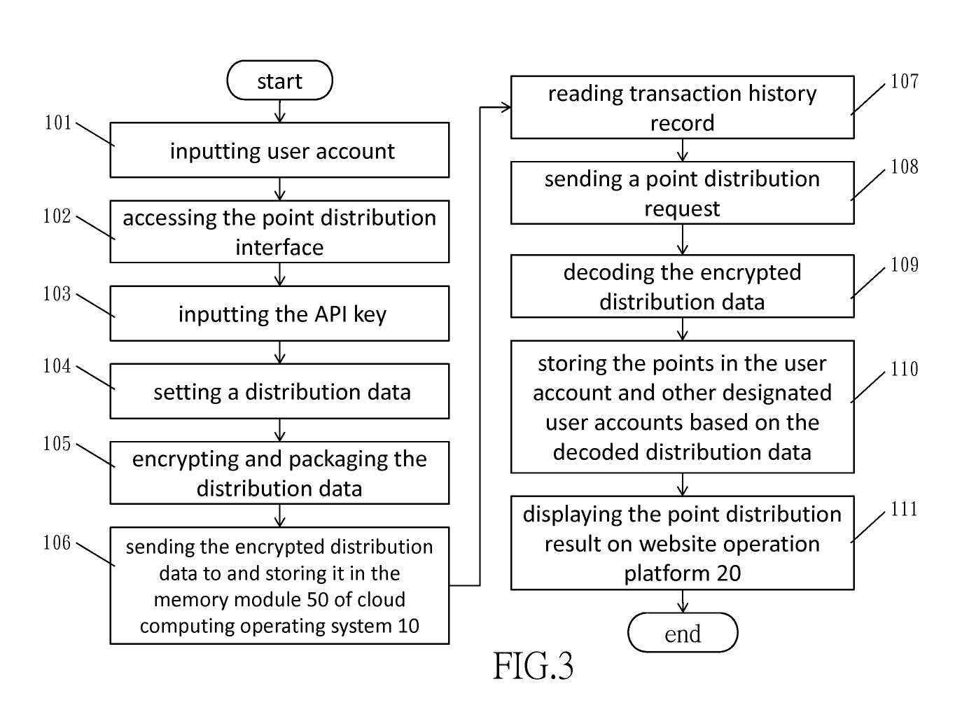

Referring to FIG. 3, an online point distribution method in accordance with the present invention comprises the following steps: step 101: the stores A access website operation platform 20 by inputting user account; step 102: accessing an operating interface via the API 31; step 103: obtaining an API key corresponding to the user account, then inputting the API key into the operating interface of the API 31; step 104: setting a distribution data 310 which includes the user account, consumer identification code 311, the percentage 312 of points, and a distribution mode 313 of the stores A and the consumers B by using the operating interface of the API 31; step 105: encrypting and packaging the distribution data 310; step 106: sending the encrypted distribution data 310 to and storing it in the memory module 50 of cloud computing operating system 10.

When website operation platform 20 outputs a transaction history record to the memory module 50, the memory module 50 will read (step 107) and send a point distribution request to the calculation module 40 of cloud computing operating system 10 (step 108). The calculation module 40 decodes the encrypted distribution data stored in the memory module 50 (step 109), and then the calculation module 40 stores the points in the user account and other designated user accounts based on the decoded distribution data (step 110), and finally the point distribution result is displayed on website operation platform 20 (step 111).

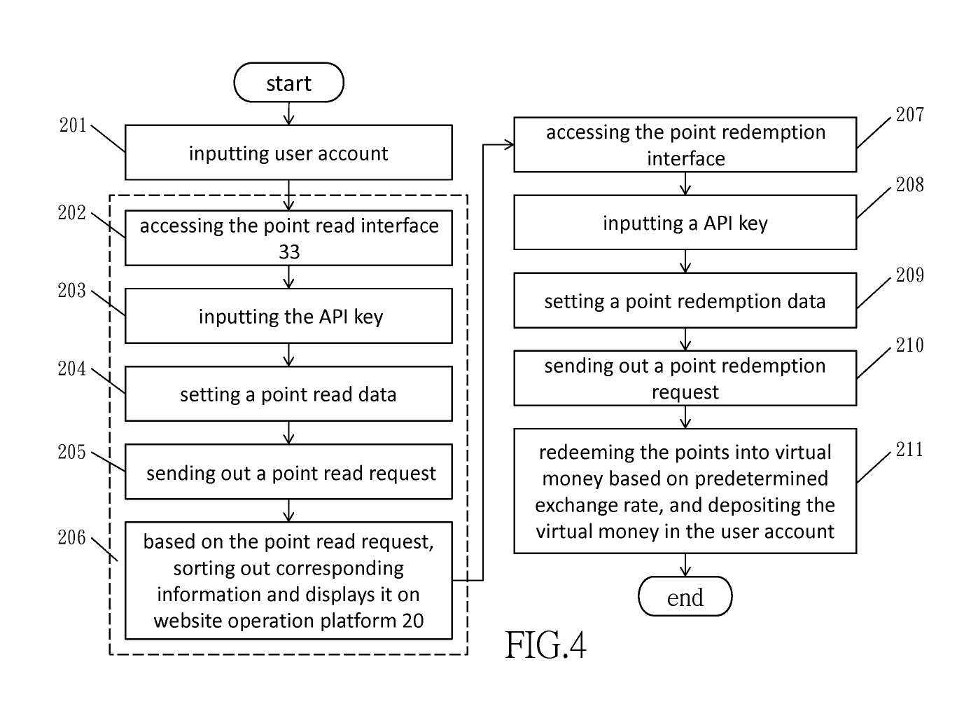

Referring to FIG. 4, an online point redemption method in accordance with the present invention comprises the following steps: the consumers B access website operation platform 20 by inputting user account (step 201), then chooses to or not to read the types and source of points and balance of points in their user account by following the following steps of 202 to 206.

Firstly, accessing the operating interface of the API 33 (step 202); obtaining an API key corresponding to the user account, then inputting the API key into the operating interface of the API 33 (step 203); setting a point read data by using the operating interface of the API 33 (step 204); sending a point read request from the operating interface of the API 33 to the memory module 50 of cloud computing operating system 10 (step 205); then based on the point read request, the memory module 50 sorts out corresponding information and displays it on website operation platform 20 (step 206) for the consumers' reference.

After confirming the balance of points, the consumers B can access the operating interface of the API 32 (step 207), obtaining a API key and inputting it in the operating interface of the API 33 by repeating the aforementioned steps (step 208); setting a point redemption data which includes the types and amount of the points to be redeemed (step 209) by using the API 32; sending a point redemption request to the memory module 50 of cloud computing operating system 10 (step 210); finally, the memory module 50 redeems the points into virtual money based on predetermined exchange rate, and deposits the virtual money in the user account (step 211).

While we have shown and described various embodiments in accordance with the present invention, it is clear to those skilled in the art that further embodiments may be made without departing from the scope of the present invention.

What is claimed is:

1. An online point distribution method for used in combination with an online point redemption and distribution system to calculate and save points produced by online transaction, comprising:
making stores access the website operation platform by inputting a user account;
forming an encrypted distribution data in the point distribution interface and sending the encrypted distribution data to the memory module;
sending a point distribution request to the computing module of the cloud computing operating system from the memory module when a transaction history record is outputed to the memory module from the website operation platform;
using the computing module to decode the encrypted distribution data stored in the memory module;
using the computing module to store the points in the user account and other designated user accounts based on a decoded distribution data; and
displaying a point distribution result on the website operation platform;
wherein the distribution data is preset by the stores and includes the user account, a consumer identification code, a percentage of points, and a distribution mode of the stores and the consumers.

2. The online point distribution method as claimed in claim 1, wherein the step of forming the encrypted distribution data in the point distribution interface includes:
making stores access the website operation platform by inputting a user account;
obtaining an application programming interface key corresponding to the user account, then inputting the application programming interface key into the point distribution interface;
setting a distribution data which includes the user account, the consumer identification code, the percentage of points of the stores and the consumers and corresponding distribution mode by using the point distribution interface;
encrypting and packaging the distribution data, and sending the encrypted distribution data to the memory module of the cloud computing operating system.

3. The online point distribution method as claimed in claim 2, wherein the distribution data includes parameters and weighting factors, and the parameters include store's designation, consumer level, recommendation, consumption points, quantity of order, and groups.

4. The online point distribution method as claimed in claim 3, wherein the definitions of the parameters includes:
the store's designation: the stores decide whether or not and how to distribute;
the consumer level: define levels and percentage of the distribution, and the stores can select one of the levels;
the recommendation: define where the consumers came from, for example, from the internet or recommended by other consumers, so that the consumers from the Internet become a source of upper level points, and those recommended by other consumers form the points to be distributed at the lower level;
the consumption points: calculate the total value of money of the past transactions and convert it into points;
the quantity of order: the quantity of virtual or actual orders made in the stores; and
the groups: classify the consumers into groups of male, female or other groups with special needs.
